(19) United States
(12) Patent Application Publication
(10) Pub. No.: US 2006/0294585 A1
(43) Pub. Date: Dec. 28, 2006

(54) System and method for creating and managing a trusted constellation of personal digital devices

(75) Inventors: Vladimir Sadovsky, Bellevue, WA (US); Oren Rosenbloom, Redmond, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/166,739

(22) Filed: Jun. 24, 2005

(51) Int. Cl. G06F 12/14; G06F 17/30; H04L 9/32; G06F 12/00; G06F 13/00; G06F 7/04; G06F 7/58; G06K 19/00; G11C 7/00

(52) U.S. Cl. 726/17; 726/18; 726/19

(57) ABSTRACT

A system comprises a PC and a plurality of personal digital devices, each device to store one of a plurality of sets of credentials in an internal secured storage area. A method of managing a constellation of trusted devices comprises coupling a device with the PC, adding the device to the constellation if the device is not a member of the constellation, and transmitting the set of credentials from the PC to the internal secured storage area if the device does not have the credentials. A method of enabling communication between devices comprises coupling a first personal digital device with a second personal digital device, validating both devices, authenticating both devices, and prompting both devices to couple with the PC to become members of the constellation and obtain new sets of credentials if both devices are not authenticated and validated.

### CROSS-REFERENCE TO RELATED APPLICATIONS

This invention is related to the application entitled “System and method for facilitating communication between a computing device and multiple categories of media devices,” which was filed on May 2, 2003, and which is designated as U.S. application Ser. No. 10/429,116.

### STATEMENT REGARDING FEDERALLY SPONSORED RESEARCH OR DEVELOPMENT

Not applicable.

### TECHNICAL FIELD

The present invention relates to personal digital devices. More particularly, the present invention relates to secure communication between personal digital devices.

### BACKGROUND OF THE INVENTION

The use of personal digital devices such as cellular telephones, Blackberries, PDAs, digital cameras, portable music players, etc. is increasing as processing power increases and price decreases. Peer-to-peer (P2P) data and settings exchange between such devices is becoming more and more pervasive, especially as networking protocols and physical interconnection methods standardize.

In order to establish secure and trusted data exchange between personal digital devices belonging to the same user or family/group of friends, it is necessary to ensure the authenticity of each device. Otherwise, anyone with a personal digital device may be able to establish communication with a device of an unsuspecting user. One way to ensure authenticity is to require a user to log in to the device, e.g., by inputting a username and password. However, some devices such as basic digital cameras, may not have adequate user interface (UI) capabilities. For example, to accept usernames and passwords, a way of inputting alphanumeric characters is required, e.g., a keyboard, touch screen, virtual keyboard navigated with arrow and select buttons, etc. Implementing a full keyboard on a small device such as a digital camera would require increasing the size of the camera or reducing the size of the keyboard. The first option would make the camera unpleasant to carry around, and the second option would make the keyboard unusable for all but the most slender fingers. Implementing a touch screen would require a large enough screen or a pointing device. The first option would also increase the size of the device, and the second option would add components to the device that may get lost and that may simply be undesirable for the user. Implementing a virtual keyboard would make the process of entering alphanumeric characters ungainly, e.g., the user would have to navigate and select using arrows. While some personal digital devices such as PDAs and Blackberries already have sufficient UI capabilities to support the inputting of usernames and passwords, such devices cannot securely communicate with devices that do not have sufficient UI capabilities, because the devices without sufficient UI capabilities cannot be authenticated or authenticate other devices.

### SUMMARY OF THE INVENTION

The present invention enables secure communication between personal digital devices in a trusted constellation by managing the constellation on a PC. In order to join the constellation, a device must be coupled with the PC by a user. The device receives a set of credentials from the PC and stores the credentials in an internal secured storage area. When the device encounters another device with which it desires to communicate in trusted fashion, the devices validate and authenticate before communicating. The validation involves examining credentials on the other device to determine whether the devices are members of the same constellation. If the devices are not members of the same constellation, they are prompted to couple with the PC to become members. By managing the constellation on the PC, a user is able to securely control the access privileges of each device in the constellation, add devices, and remove devices easily and reliably. A UI on each device is not required, allowing the present invention to be implemented where users have existing devices that do not have sufficient UI capabilities.

### BRIEF DESCRIPTION OF THE SEVERAL VIEWS OF THE DRAWINGS

The present invention is described in detail below with reference to the attached drawing figures, wherein:

FIG. 1 is a block diagram of a computing system environment suitable for use in implementing the present invention;

FIG. 2 is a diagram of a personal computer managing a constellation of trusted devices, according to embodiments of the present invention;

FIG. 3 is a diagram of two personal digital devices communicating with each other, according to embodiments of the present invention;

FIG. 4 is a flowchart illustrating a method of adding personal digital devices to a constellation of trusted devices; and

FIG. 5 is a flowchart illustrating a method of enabling secure communication between personal digital devices that are members of the same constellation of trusted devices.

### DETAILED DESCRIPTION OF THE INVENTION

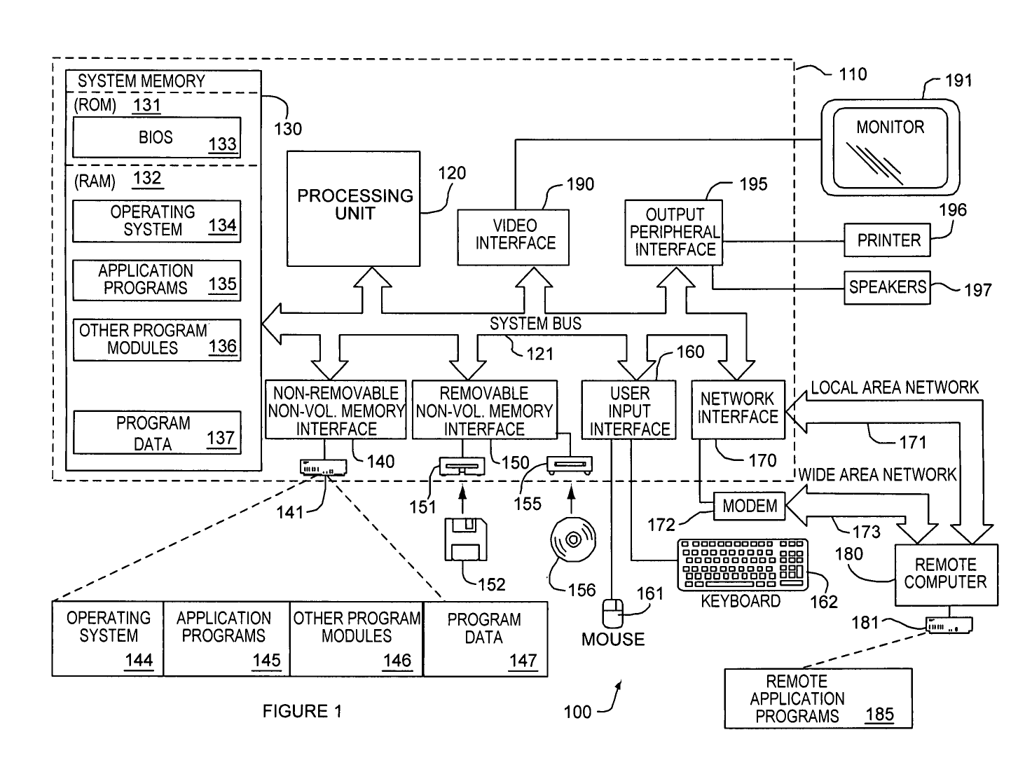

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Interconnect (PCI) bus also know as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable medial may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently begin operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drive and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different number here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through a output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user network interface 170, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

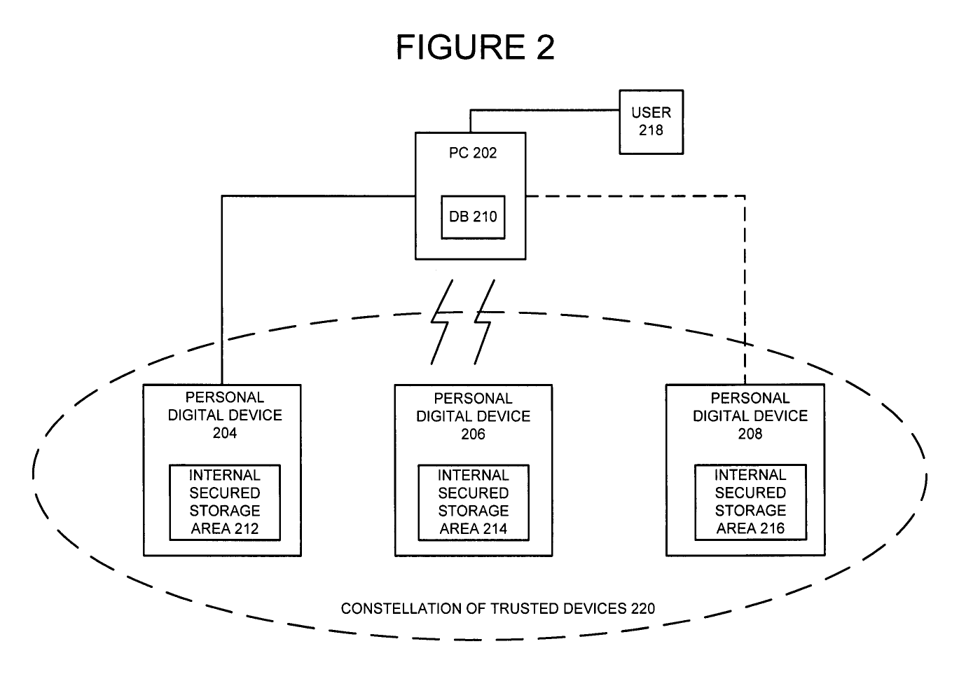

FIG. 2 is a diagram of a personal computer managing a constellation of trusted devices, according to embodiments of the present invention. As illustrated in FIG. 2, PC 202 is a personal computer that is associated with user 218. While only a single user is illustrated in FIG. 2, embodiments of the present invention are not limited to a single user of PC 202. For example, PC 202 may be a family computer with several family members as other users. PC 202 may be any personal computer, such as a desktop, laptop, notebook, handheld, pocket, etc. PC 202 manages constellation of trusted devices 220. As illustrated in FIG. 2, constellation 220 includes a plurality of personal digital devices, namely 204, 206, and 208. However, embodiments of the present invention are not limited to any particular number of devices in the constellation, as there may exist more or less devices than the three illustrated in FIG. 2. In addition, embodiments of the present invention are not limited to any particular number of constellations, and only one is illustrated in FIG. 2 for simplicity.

Constellation 220 is a theoretical grouping of devices that are related to user 218 somehow, e.g., by personal ownership, by ownership by a friend/relative, etc. When user 218 wishes to securely share information between personal digital devices 204, 206, and 208, user 218, via PC 202, establishes constellation 220 and adds devices to constellation 220 as described later herein. Each of the devices are somehow individually and securely coupled with PC 202 via wireless or wired coupling or via transportable storage media. As illustrated in FIG. 2, device 204 is coupled with PC 202 via wired coupling, device 206 is coupled with PC 202 via wireless coupling, and device 208 is coupled with PC 202 via transportable storage media. In an embodiment, the transportable storage media is a flash memory card; however, embodiments of the present invention are not limited to any particular transportable storage media. For example, the media may be a portable USB drive.

Personal digital devices 204, 206, and 208 may be any of a number of devices, and the present invention is not limited to any particular set of devices. For example, the devices may be cellular phones, digital cameras, PDAs, Blackberries, portable music players, automotive multimedia systems, etc. Also, embodiments of the present invention are not limited to any particular devices being coupled with PC 202 in any particular manner. For example, all of the devices in constellation 220 may be coupled with PC 202 via wireless coupling, or four devices may be coupled wirelessly, two devices may be coupled via wired coupling, and seven devices may be coupled via transportable storage media. FIG. 2 simply illustrates three devices and the general ways in which they may be coupled to PC 202 for ease of illustration and discussion.

PC 202 comprises DB 210, which is a database that is used to store a plurality of sets of credentials. In an embodiment, a set of credentials is a string of bits that are used to establish proof of identification. In an embodiment, a set of credentials stored in DB 210 comprises information identifying a constellation (e.g., a constellation name or ID), information identifying the PC (e.g., a PC name or ID), information identifying a device (globally or locally) (e.g., a device name or ID, which is assigned by the device manufacturer in an embodiment), information about a user (e.g., a user name or ID), a public key/private key pair, and device privileges. In an embodiment, the information in the set of credentials will be defaults. In an embodiment, user information is entered via a UI on PC 202 (discussed herein below). In an embodiment, a set of credentials is a firmware update.

Each of the sets of credentials in the plurality of sets of credentials is destined for a different personal digital device in constellation 220. As illustrated in FIG. 2, each device has an internal secured storage area, labeled 212, 214, and 216, respectively. Each internal secured storage area is used to store a set of credentials for constellation 220. In an embodiment, the internal secured storage areas are managed by firmware, and are a portion of flash storage inside the device, which is reasonably tamper proof. The only way to access the internal secured storage areas is through secured communication with firmware, and communication is secured by proper authentication. Therefore, a non-authenticated device will not be able to read from the internal secured storage area, while the PC can. In an embodiment, devices may be a part of multiple constellations, and in that case, the internal secured storage area would store multiple sets of credentials, one per each constellation.

Using PC 202, user 218 manages the credentials of the devices in constellation 220. User 218 interacts with PC 202 via a user interface (UI), which is not illustrated in FIG. 2. User 218 logs in to PC 202 via the UI using any well known method of login, which enables PC 202 to gather user information for the plurality of sets of credentials. User 218 couples each device in constellation 220 with PC 202 (the devices do not have to all be coupled with PC 202 at the same time or even close in time with one another). Because user 218 logs into PC 202 and himself couples the devices to PC 202, it can be assumed that the devices are trusted by user 218. Therefore, each device does not need to have a separate UI by which user 218 logs in. Further, this enables existing devices that lack sufficient UI capabilities to join constellation 220.

As will be discussed in greater detail later herein, when user 218 desires to add a device to constellation 220 (for example, after being prompted to confirm that the device is to be added), a set of credentials is transmitted from DB 210 to the respective internal secured storage area on the device. In an embodiment, a standardized data exchange protocol is used to transmit the credentials to the devices. In a further embodiment, MTP (media transfer protocol) is the standardized data exchange protocol. However, embodiments of the present invention are not limited to any particular protocol, as any of a number of different protocols may suffice. For example, HTTP may be used, where devices may not be physically close but may be communicating remotely, e.g., a digital camera accessing a home printer via the Web from a vacation location. If user 218 desires to add other devices to constellation 220, user 218 repeats the process for each device. In an embodiment, if constellation 220 has not yet been created by user 218, user 218 may create constellation 220 via the UI.

In managing constellation 220, user 218 controls any particular sharing privileges of individual devices, in an embodiment of the present invention. For example, user 218 may wish to limit a particular device to read-only access. User 218 may also cancel any or all sets of credentials, for example, if one or more devices are lost, stolen, damaged, etc. The remaining trusted devices in constellation 220 (if any) are coupled with PC 202 by user 218 to receive updated credentials, and are notified of the cancellation and thereafter will not authenticate with the canceled device (see authentication discussion herein below). Such cancellation/updating allows user 218 to quickly and easily prevent the lost or stolen device to be used by another unauthorized person to continue sharing data. By managing constellation 220 and its credentials on PC 202, a lost, stolen, damaged, etc. device does not have to be recovered to be removed from constellation 220, and all remaining devices can be quickly updated to continue communicating with one another but not the compromised device.

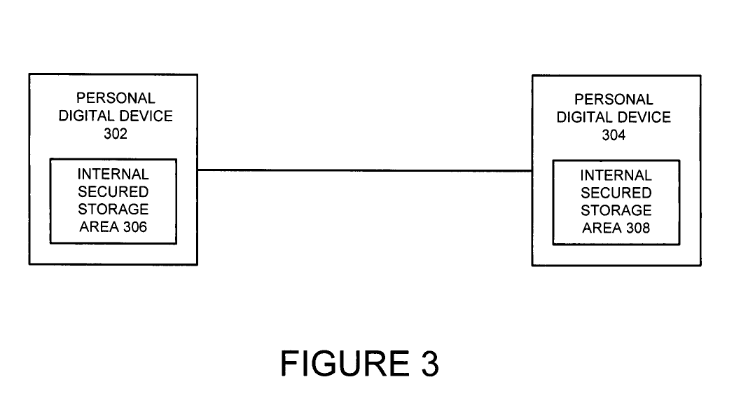

FIG. 3 is a diagram of two personal digital devices communicating with each other, according to embodiments of the present invention. As will be discussed in greater detail later herein, after devices are added to a constellation, they may communicate directly with one another away from the presence of the PC. As illustrated in FIG. 3, personal digital device 302 may communicate directly with personal digital device 304. In an embodiment, devices 302 and 304 are representative of two of the devices discussed with regard to FIG. 2. As illustrated in FIG. 3, device 302 comprises internal secured storage area 306, and device 304 comprises internal secured storage area 308. In an embodiment, internal secured storage areas 306 and 308 are representative of two of the internal secured storage areas discussed with regard to FIG. 2.

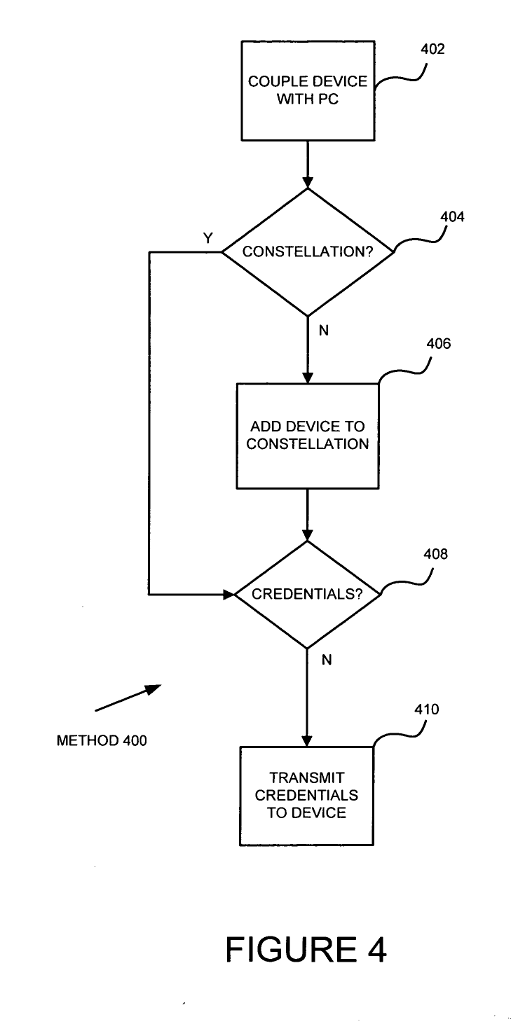

FIG. 4 is a flowchart illustrating a method of adding personal digital devices to a constellation of trusted devices. As discussed above, devices need to be added to the constellation in order to be considered “trusted devices.” In an embodiment of the present invention, a PC is used to manage the constellation and add/remove devices. After joining the constellation, devices can communicate sensitive information with one another. FIG. 4 is not intended to limit the present invention to one device being coupled with the PC at a time, as multiple devices may be coupled with the PC at any given time.

As illustrated in FIG. 4, method 400 begins with a device being coupled with a PC (402). As discussed above, the device may be coupled via wired or wireless coupling, or via transportable storage media. The PC determines whether the device is already a member of a constellation of trusted devices (404). If the device is not a member of the constellation and a user of the PC and the device wishes to add the device to the constellation, the device is added to the constellation (406). While not illustrated in FIG. 4, the user may choose not to add the device to the constellation, in which case the device is still usable connecting to the PC, but will not be allowed to securely communicate with other constellation devices. The PC verifies that the device has a particular set of credentials for the constellation (408). If the device is already a member of the constellation, the PC verifies that the credentials are up-to-date. If the device is newly-added to the constellation, the device will not have credentials pertaining to the constellation. If the device has no or out-of-date credentials, the PC transmits the credentials to the device (410), as discussed above.

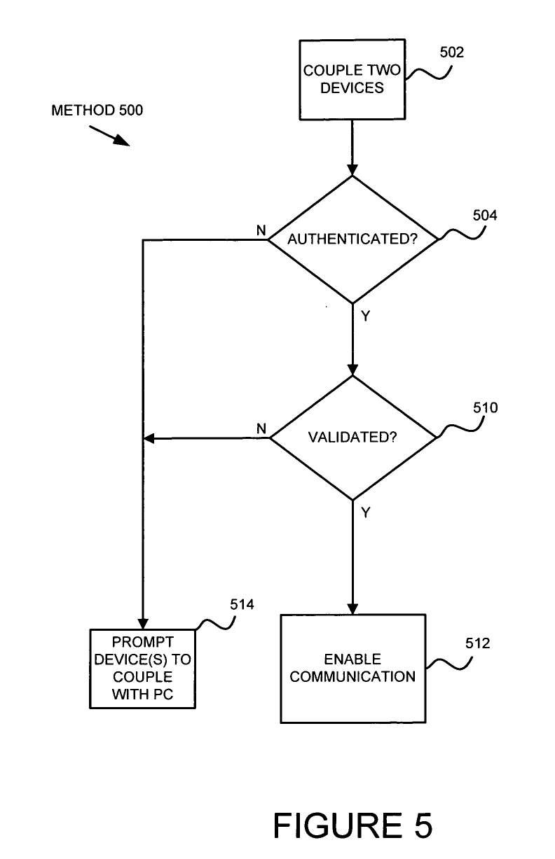

FIG. 5 is a flowchart illustrating a method of enabling secure communication between personal digital devices that are members of the same constellation of trusted devices. Method 500 begins with two personal digital devices being coupled together (502). As discussed above, the devices may be coupled via wired or wireless coupling. Each device attempts to authenticate the other by determining whether the other device is a member of a common constellation of trusted devices using well known authentication algorithms (504). In an embodiment, the authentication algorithm is a well known PKI authentication algorithm such as RSA authentication. During authentication, one device issues a challenge (e.g., a string encoded by a private key) together with a digitally signed constellation name, and the other device has to respond correctly, based on its own private key. If the credentials of the devices match, the response will fit the challenge, in which case the devices are members of the same constellation. If the two devices are not members of a common constellation, they are not authenticated, and each device is prompted to couple with a common PC to join the common constellation (514). If the two devices are members of a common constellation, they are each authenticated. If both devices are authenticated, each device then attempts to validate (510) During validation, each device checks rights to determine whether there are sufficient rights to perform the requested action. For example, even though two devices may have authenticated successfully, one may not have privileges to perform a write action, so it would fail validation. More specifically, if a camera, TV, and personal video player are all in the same constellation, the user can configure the constellation on the PC to allow the TV to request images from the camera and to prevent the personal video player from requesting images. When the camera comes into contact with the personal video player, both will authenticate each other, but the camera won't provide images to the personal video player, because the personal video player is not validated to request images from the camera. If a device fails to validate, it may be prompted to couple with a common PC to update its privileges (514). If the devices are validated, they are then enabled to communicate with each other (512). In an embodiment, a standardized data exchange protocol such as MTP is used to communicate between both devices.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

The invention claimed is:

1. A system, comprising:
a personal computer to manage a constellation of trusted devices, comprising:
a database to store a plurality of sets of credentials;
a plurality of personal digital devices in the constellation, each device comprising:
an internal secured storage area to store one of the plurality of sets of credentials;
wherein the plurality of personal digital devices are each coupled with the personal computer to receive one of the plurality of sets of credentials via secured wireless or wired coupling or via transportable storage media.

2. The system of claim 1, wherein a standardized data exchange protocol is used to transmit the plurality of sets of credentials from the personal computer to the plurality of personal digital devices.

3. The system of claim 2, wherein the standardized data exchange protocol is MTP (media transfer protocol).

4. The system of claim 1, wherein the plurality of sets of credentials are stored in each internal secured storage area through firmware operations, updating the internal secured storage areas.

5. The system of claim 1, wherein the personal computer further comprises:
a user interface to authenticate a user and to enable the user to manage the constellation.

6. The system of claim 5, wherein the user authentication comprises receiving at least a portion of each of the plurality of sets of credentials from the user.

7. The system of claim 5, wherein the user managing the constellation comprises managing privileges of the plurality of personal digital devices.

8. The system of claim 5, wherein the user managing comprises canceling the plurality of sets of credentials.

9. The system of claim 5, wherein the user managing comprises updating the plurality of sets of credentials.

10. A method, comprising:
coupling a personal digital device with a personal computer via secured wireless or wired coupling or via transportable storage media;
determining whether the personal digital device is a member of a constellation of trusted devices;
if the personal digital device is not a member of the constellation, adding the personal digital device to the constellation;
determining whether the personal digital device has a set of credentials stored in an internal secured storage area; and
if the personal digital device does not have the set of credentials stored in the internal secured storage area, transmitting the set of credentials from a database in the personal computer to the internal secured storage area on the personal digital device.

11. The method of claim 10, wherein a standardized data exchange protocol is used to transmit the set of credentials from the personal computer to the personal digital device.

12. The method of claim 11, wherein the standardized data exchange protocol is MTP (media transfer protocol).

13. The system of claim 10, further comprising:
storing the set of credentials in the internal secured storage through a firmware operation, updating the internal secured storage area.

14. The system of claim 10, further comprising:
authenticating a user on the personal computer; and
enabling the user to manage the constellation on the personal computer.

15. The system of claim 14, wherein the user authentication comprises receiving at least a portion of the set of credentials from the user.

16. The system of claim 10, further comprising:
managing privileges of the personal digital device.

17. The system of claim 10, further comprising:
canceling the set of credentials.

18. The system of claim 10, further comprising:
updating the set of credentials.

19. A method, comprising:
coupling a first personal digital device with a second personal digital device;
determining whether the second device is a member of a constellation of trusted devices of which the first device is a member;
if the second device is a member of the constellation, authenticating the second device and determining whether the second device has at least a portion of a set of credentials in an internal secured storage area;
if the second device has the at least a portion of the set of credentials, validating the second device and enabling communication between the devices; and
if the second device is not authenticated and validated, prompting the second device to couple with a personal computer to become a member of the constellation and obtain a new set of credentials via secured wireless or wired coupling or via transportable storage media.

20. The method of claim 19, wherein MTP (media transfer protocol) is used to communicate between both devices.
